(19) United States
(12) Patent Application Publication
(10) Pub. No.: US 2023/0123606 A1
(43) Pub. Date: Apr. 20, 2023

(54) NARROW-BAND GREEN LUMINOPHORE

(71) Applicant: ams-OSRAM International GmbH, Regensburg (DE)

(72) Inventors: Dominik BAUMANN, Munich (DE); Simon PESCHKE, Assling (DE); Philipp SCHMID, Germering (DE)

(21) Appl. No.: 17/917,263

(22) PCT Filed: Mar. 30, 2021
(86) PCT No.: PCT/EP2021/058221

§ 371 Date: Oct. 6, 2022

(30) Foreign Application Priority Data
Apr. 6, 2020 (DE) 10 2020 204 429.5

(51) Int. Cl. C09K 11/77

(52) U.S. Cl. CPC C09K 11/77922

(57) ABSTRACT

A luminophore may have the general molecular formula NaᵥKₓRb_{y}Li_{z}Cs_{w} (Li₃SiO₄)4:E, where:
v+x+y+z+w = 4;
0 < v < 4;
0 < x < 4;
0 < y < 4;
0 < z < 4;
0 < w < 4; and
E = Eu, Ce, Yb, Mn, or combinations thereof.

### CROSS-REFERENCE TO RELATED APPLICATIONS

The present application is a national stage entry according to 35 U.S.C. §371 of PCT application No.: PCT/EP2021/058221 filed on Mar. 30, 2021; which claims priority to German patent application DE 10 2020 204 429.5, filed on Apr. 6, 2020; all of which are incorporated herein by reference in their entirety and for all purposes.

### TECHNICAL FIELD

The disclosure relates to a phosphor and to a lighting device, which in particular comprises the phosphor.

### BACKGROUND

In the field of consumer electronics, manufacturers endeavor to find unique features for marketing their products. For many devices with displays, such as televisions, computer monitors, tablets and smartphones, bright and natural colors are particularly important for the customers.

In light sources for use in the backlighting of LCD displays and in most other types of display, the colors are rendered by addition of three primary colors (red, blue and green). The gamut of colors which can be represented on such a display (color space) is therefore restricted to the triangle which can be formed by the color points of the three primary colors. These are extracted from the spectrum of the backlighting by three color filters. The range of the wavelengths transmitted by these filters, however, is quite broad. This necessitates a light source having a spectrum which consists of three narrow-band emission peaks in order to obtain the maximal color space.

In the case of LEDs for backlighting applications, a suitable emission spectrum is generally achieved by the combination of a blue-emitting LED chip having a green and a red phosphor with emission peaks that are as narrow-band as possible. In the ideal case, the emission peaks fully correspond to the transmission bands of the color filters in order to waste as little light as possible and to achieve a maximal efficiency, and to minimize overlaps/crosstalk between the various color channels, which leads to a reduction of the achievable color space.

There is a need for phosphors which emit with a narrow band in the green spectral range.

### SUMMARY

It is an objective to provide a phosphor which emits radiation in the green spectral range and has a small full-width at half maximum. It is furthermore an objective to provide a lighting device having the advantageous phosphor described herein.

A phosphor is provided. The phosphor is doped with an activator E, where E = Eu, Ce, Yb and/or Mn. In particular, the activator is responsible for the emission of radiation by the phosphor. The phosphor has the general molecular formula NaᵥKₓRb_{y}Li_{zC}s_{w}(Li₃SiO₄) _{4:} E, wherein
v+x+y+z+w = 4;
0 < v < 4;
0 < x < 4;
0 < y < 4;
0 < z < 4;
0 < w < 4 and
E = Eu, Ce, Yb and/or Mn, such as E = Eu alone or in combination with Ce, Yb and/or Mn, or E = Eu.

Here and in what follows, phosphors are described with the aid of molecular formulae. In the molecular formulae specified, it is possible for the phosphor to comprise further elements, for instance in the form of impurities, although these impurities may in total have at most a proportion by weight in the phosphor of at most 1 part per thousand or 100 ppm (parts per million) or 10 ppm.

The nomenclature of the molecular formula NaᵥKₓRb_{y}Li_{z}Cs_{w} (Li₃SiO₄)₄: E, in which lithium is mentioned two times, is widely known to a person skilled in the art of inorganic chemistry. In particular, this molecular formula illustrates to the person skilled in the art that the lithium may occupy different positions within the crystal structure of the phosphor. An alternative nomenclature to the general molecular formula NaᵥKₓRb_{y}Li_{z}Cs_{w}(Li₃SiO₄) _{4:} E is NaᵥKₓRb_{y}Cs_{w}Li_{12+z}Si₄O_{16:} E.

The inventors have in the present case succeeded in synthesizing an efficient phosphor which contains five different alkali metals.

According to at least one embodiment, the phosphor has the general molecular formula NaᵥKₓRb_{y}Li_{z}Cs_{w}(Li₃SiO₄)₄:E, wherein
v+x+y+z+w = 4;
0 < v ≤ 3;
0 < x ≤ 3;
0 < y ≤ 3;
0 < z ≤ 3;
0 < w ≤ 3 and
E = Eu, Ce, Yb and/or Mn, such as E = Eu alone or in combination with Ce, Yb and/or Mn, or E = Eu.

Surprisingly, in response to excitation with primary radiation, the phosphors with the molecular formula NaᵥKₓRb_{y}Li_{z}Cs_{w}(Li₃SiO₄)₄:E, which contain five different alkali metal ions, have emission or secondary radiation in the green spectral range and exhibit a low full-width at half maximum. The phosphors advantageously have only one emission band, or only one emission peak. In this way, it is possible to ensure that the color locus of the emitted radiation of the phosphors is shifted at most slightly when there is a change in temperature. In particular, the shift of the color locus is much less pronounced than in the case of a phosphor having two emission bands, which furthermore have a different quenching behavior.

Here and in what follows, the full-width at half maximum is intended to mean the spectral width at half height of the maximum of an emission peak, or of an emission band, abbreviated to FWHM.

According to at least one embodiment, the phosphor has the general molecular formula NaᵥKₓRb_{y}Li_{z}Cs_{w}(LiₛSiO₄)₄:E, wherein
v+x+y+z+w = 4;
0 < v ≤ 2;
0 < x ≤ 2;
0 < y ≤ 2;
0 < z ≤ 2;
0 < w ≤ 2 and
E = Eu, Ce, Yb and/or Mn, such as E = Eu alone or in combination with Ce, Yb and/or Mn, or E = Eu.

According to at least one embodiment, the phosphor has the general molecular formula NaᵥKₓRb_{y}Li_{z}Cs_{w}(Li₃SiO₄)₄:E, wherein
v+x+y+z+w = 4;
0.05 ≤ v ≤ 1.50;
0.05 ≤ x ≤ 1.50;
0.05 ≤ y ≤ 1.50;
0.05 ≤ z ≤ 1.50;
0.05 ≤ w ≤ 1.50 and
E = Eu, Ce, Yb and/or Mn, such as E = Eu alone or in combination with Ce, Yb and/or Mn, or E = Eu.

The phosphor with the molecular formula NaᵥKₓRb_{y}Li_{z}Cs_{w}(Li₃SiO₄)₄:E advantageously has a peak wavelength in the range of between 529 nm and 539 nm inclusive, and the full-width at half maximum lies between 40 nm and 45 nm. In particular, the emission spectrum of the phosphor has only one emission peak and therefore exhibits, in particular, no double emission. In other words, the emission of the phosphor in particular does not have a relative maximum, but only an absolute maximum, which corresponds to the peak wavelength. In this way, a very high color purity and a very high luminous efficiency (LER) are achieved.

In the present case, the “peak wavelength” refers to the wavelength in the emission spectrum of a phosphor at which the maximum intensity lies in the emission spectrum, or an emission band.

According to at least one embodiment, the phosphor has the general molecular formula NaᵥKₓRb_{y}Li_{z}Cs_{w}(Li₃SiO₄)₄:E, wherein
v+x+y+z+w = 4;
0.50 ≤ v ≤ 1.50;
0.50 ≤ x ≤ 1.50;
0.50 ≤ y ≤ 1.50;
0.50 ≤ z ≤ 1.50;
0.05 ≤ w ≤ 0.5 and
E = Eu, Ce, Yb and/or Mn, such as E = Eu alone or in combination with Ce, Yb and/or Mn, or E = Eu.

Known phosphors with the molecular formula A₄ (Li₃SiO₄) ₄: E, in which A stands for two different alkali metal ions, also already have peak wavelengths in the green spectral range and exhibit a low full-width at half maximum. Rb₂Li₂ (Li₃SiO₄)₄ :Eu²⁺ and Rb₂Na₂(Li₃SiO₄)₄:Eu²⁺ are examples of narrow-band green phosphors having only one emission peak, the peak wavelengths lying at 530 nm and the full-width at half maximum being 42 nm (Ming Zhao et al., Advanced Materials, 2018, 1802489, “Next-Generation Narrow-Band Green-Emitting RbLi (Li₃SiO₄) ₂:Eu²⁺ Phosphor for Backlight Display Application”; Hongxu Liao et al., Advanced Functional Materials 2019, 1901988, “Polyhedron Transformation toward Stable Narrow-Band Green Phosphors for Wide-Color-Gamut Liquid Crystal Display”).

There are also examples of phosphors with the molecular formula A₄ (Li₃SiO₄) ₄ : E, in which A stands for two different alkali metal ions, which emit in a narrow band with a peak wavelength in the blue spectral range. One example of such a phosphor is RbNa₃ (Li₃SiO₄) ₄: Eu²⁺ with a peak wavelength at 471 nm and a full-width at half maximum of only 22.4 nm (Hongxu Liao et al., Angewandte Chemie, 2018, 130, p 1-5, “Learning from a Mineral Structure toward an Ultra-Narrow-Band Blue-Emitting Silicate Phosphor RbNa₃(Li₃SiO₄)₄: Eu²⁺”) .

There are, however, also examples of known phosphors with the molecular formula A₄ (Li₃SiO₄) ₄ : E, in which A stands for two different alkali metal ions, which have an undesired double emission with one emission peak in the blue spectral range and one emission peak in the green spectral range. Examples are (Na_{0.5}K_{0.5}) ₄ (Li₃SiO₄) ₄ :Eu, which exhibits an emission peak at 486 nm and an emission peak at 530 nm, and NaK₇ (Li₃SiO₄) ₈: Eu, which has one emission peak at 515 nm and one emission peak at 598 nm (Ming Zhao et al., Light: Science & Applications, 2019, “Emerging ultra-narrow-band cyan-emitting phosphor for white LEDs with enhanced color rendition”; Daniel Dutzler et al., Angewandte Chemie Int. Ed. 2018, 57, 1-6, “Alkali Lithosilicates: Renaissance of a Reputable Substance Class with Surprising Luminescence Properties”).

If the number of alkali metal ions A in the molecular formula A₄(Li₃SiO₄)₄ : E is increased to three or four different alkali metal ions, the phosphors exclusively exhibit double emissions. For instance, the phosphor Cs_{4-x-y-z}RbₓNa_{y}Li_{z}[Li₃SiO₄]₄ : Eu has one emission peak at 473 nm and one emission peak at 531 nm (F. Ruegenberg et al., Chemistry, A European Journal, 2020, 26, 1-8, “A Double-Band Emitter with Ultranarrow-Band Blue and Narrow-Band Green Luminescence”; FIG. 10), the phosphor CsKNa_{1.98-y}Li_{y} (Li₃SiO₄) ₄:0.02Eu²⁺ with 0 ≤ y ≤ 1 has one emission peak at 485 nm and one emission peak at 526 nm (Wei Wang et al., Chemistry of Materials 2019, “Photoluminescence Control of UCr4C4-Typed Phosphors with Superior Luminous Efficiency and High Color Purity via Controlling Site-Selection of Eu²⁺ Activators”) and the phosphors RbNa₂K (Li₃SiO₄) ₄: Eu²⁺ and CsNa₂K (Li₃SiO₄) ₄:Eu²⁺ respectively have one emission peak at about 480 nm/485 nm and one emission peak at about 531 nm (Ming Zhao et al., Advanced Optical Materials, 2018, “Discovery of New Narrow-Band Phosphors with the UCr4C4-Related Type Structure by Alkali Cation Effect”).

From the known phosphors with the molecular formula A₄ (Li₃SiO₄) ₄:E, a clear trend toward double emission and therefore an increase of the emission in the blue spectral range may be seen when there are more different alkali metal ions in the phosphor. Especially for backlighting applications, however, narrow-band phosphors with only one emission peak in the green spectral range are needed in order to waste as little light as possible, to achieve a maximal efficiency, and to minimize overlaps/crosstalk between the various color channels.

It is all the more surprising that the emission spectrum of the phosphor with the general formula NaᵥKₓRb_{y}Li_{z}Cs_{w}(Li₃SiO₄)₄:E, in which A in A₄ (Li₃SiO₄) ₄ : E thus stands for five different alkali metal ions, that is to say lithium, sodium, potassium, rubidium and cesium, only has one emission peak in the green spectral range and therefore advantageously does not have double emission. In other words, the emission of the phosphor in particular does not have a relative maximum, but only an absolute maximum, which corresponds to the peak wavelength.

According to at least one embodiment, the phosphor has the general molecular formula NaᵥKₓRb_{y}Li_{z}Cs_{w}(Li₃SiO₄)₄:E, wherein
v+x+y+z+w = 4;
1.00 ≤ v ≤ 1.40;
0.80 ≤ x ≤ 1.20;
0.80 ≤ y ≤ 1.20;
0.60 ≤ z ≤ 1.00;
0.05 ≤ w ≤ 0.30 and
E = Eu, Ce, Yb and/or Mn, such as E = Eu alone or in combination with Ce, Yb and/or Mn, or E = Eu.

According to at least one embodiment, the phosphor has the general molecular formula NaᵥKₓRb_{y}Li_{z}Cs_{w}(Li₃SiO₄)₄:E, wherein
v+x+y+z+w = 4;
1.08 ≤ v ≤ 1.28;
0.86 ≤ x ≤ 1.06;
0.82 ≤ y ≤ 1.02;
0.72 ≤ z ≤ 0.92;
0.05 ≤ w ≤ 0.22 and
E = Eu, Ce, Yb and/or Mn, such as E = Eu alone or in combination with Ce, Yb and/or Mn, or E = Eu.

According to at least one embodiment, the phosphor has the general molecular formula NaᵥKₓRb_{y}Li_{z}Cs_{w}(Li₃SiO₄)₄:E, wherein
v+x+y+z+w = 4;
1.16 ≤ v ≤ 1.20;
0.94 ≤ x ≤ 0.98;
0.90 ≤ y ≤ 0.94;
0.80 ≤ z ≤ 0.84;
0.10 ≤ w ≤ 0.14 and
E = Eu, Ce, Yb and/or Mn, such as E = Eu alone or in combination with Ce, Yb and/or Mn, or E = Eu.

In one embodiment, E = Eu or Eu²⁺. It has been found that there are particularly efficient phosphors with Eu²⁺ as an activator.

The activator E may, according to one embodiment, be present in mol% amounts of between 0.1 mol% and 20 mol%, 1 mol% and 10 mol%, 0.5 mol% and 5 mol%, 2 mol% and 5 mol%. Excessive concentrations of E may lead to an efficiency loss by concentration quenching. Here and in what follows, mol% specifications for the activator E, in particular Eu or Eu²⁺, are to be understood in particular as mol% specifications in relation to the molar fractions of Li, K, Na, Rb and/or Cs in the phosphor.

According to at least one embodiment, the phosphor can be excited with primary radiation between 330 nm and 500 nm, such as between 340 nm and 460 nm, or between 360 nm and 450 nm.

According to at least one embodiment, the phosphor crystallizes in a tetragonal crystal system, or in a tetragonal crystal structure.

According to at least one embodiment, the phosphor crystallizes in the space group I4/m. In a non-limiting embodiment, the lattice constants at a, b and c are 10.9 Å ≤ a ≤ 11.1 Å, 10.9 Å ≤ b ≤ 11.1 Å and 6.2 Å ≤ c ≤ 6.4 Å. Alternatively, the lattice constants at a, b, c are: a = b = 11.0063(5) Å and c = 6.3336(3) Å.

According to at least one embodiment, the phosphor has the molecular formula Na_{1.18}K_{0.96}Rb_{0.92}Li_{0.82}Cs_{0.12} (Li₃SiO₄) ₄:Eu.

The phosphor Na_{1.18}K_{0.96}Rb_{0.92}Li_{0.82}Cs_{0.12} (Li₃SiO₄) ₄ : Eu is distinguished by its peak wavelength lying at 534 nm in the green spectral range and its narrow-band nature with a full-width at half maximum of about 42 nm. Owing to the very low full-width at half maximum and the property that the emission spectrum of the phosphor has only one emission peak, the phosphor exhibits an extremely high color purity and an extremely high luminous efficiency in comparison with known green phosphors. The dominant wavelength of the phosphor is about 543 nm.

The dominant wavelength is a way of describing nonspectral (polychromatic) light mixing by spectral (monochromatic) light which produces a similar hue perception. In the CIE color space, the line which joins a point for a particular color and the point CIE-x = 0.333, CIE-y = 0.333 may be extrapolated in such a way that it meets the contour of the space at two points. The point of intersection which lies closer to said color represents the dominant wavelength of the color as a wavelength of the pure spectral color at this point of intersection. The dominant wavelength is thus the wavelength which is perceived by the human eye.

While for example the phosphors RbNa₂K (Li₃SiO₄) ₄: Eu²⁺ and CsNa₂K(Li₃SiO₄)₄:Eu²⁺ have double emission with one emission in the blue spectral range and one emission in the green spectral range, the phosphor Na_{1.18}K_{0.96}Rb_{0.92}Li_{0.82}Cs_{0.12} (Li₃SiO₄) ₄:Eu²⁺ surprisingly exhibits only one emission peak and therefore no double emission.

The inventors have therefore discovered that a new type of green phosphor having surprisingly advantageous properties may be provided.

The method for producing the phosphor is very straightforward to carry out in comparison with many other production methods for phosphors. The synthesis is carried out at moderate temperatures in the range of between 650° C. - 900° C., in particular 700° C. to 850° C. or 750° C. to 800° C. and is therefore very energy-efficient. The requirements, for example for the furnace used, are therefore minor. The reactants used are commercially available economically and are nontoxic.

The disclosure furthermore relates to a lighting device. In particular, the lighting device comprises the phosphor. In this case, all comments and definitions relating to the phosphor also apply for the lighting device, and vice versa.

A lighting device is provided. The lighting device comprises a phosphor having the general molecular formula NaᵥKₓRb_{y}Li_{z}CS_{w}(Li₃SiO₄) ₄: E, wherein
v+x+y+z+w = 4;
0 < v < 4;
0 < x < 4;
0 < y < 4;
0 < z < 4;
0 < w < 4 and
E = Eu, Ce, Yb and/or Mn, such as E = Eu alone or in combination with Ce, Yb and/or Mn, or E = Eu.

According to at least one embodiment, the lighting device comprises a semiconductor layer sequence. The semiconductor layer sequence is configured for the emission of primary electromagnetic radiation.

According to at least one embodiment, the semiconductor layer sequence comprises at least one III-V compound semiconductor material. The semiconductor material is, for example, a nitride compound semiconductor material such as AlₙIn₁₋ₙ₋ₘGaₘN, where respectively 0 ≤ n ≤ 1, 0 ≤ m ≤ 1 and n + m ≤ 1. In this case, the semiconductor layer sequence may comprise dopants as well as other constituents. For the sake of simplicity, however, only the essential constituents of the semiconductor layer sequence are specified, that is to say Al, Ga, In and N, even though they may be partially replaced and/or supplemented with small amounts of further substances. In particular, the semiconductor layer sequence is formed from InGaN.

The semiconductor layer sequence contains an active layer having at least one pn junction and/or having one or a plurality of quantum well structures. During operation of the lighting device, electromagnetic radiation is generated in the active layer. A wavelength or the emission maximum of the radiation may lie in the ultraviolet and/or visible range, in particular at wavelengths of between 330 nm inclusive and 500 nm inclusive, such as between 340 nm inclusive and 460 nm inclusive, or between 360 nm inclusive and 450 nm inclusive.

According to at least one embodiment, a wavelength or the emission maximum of the primary radiation lies in the ultraviolet range between 330 nm and 400 nm inclusive, such as between 360 nm and 400 nm inclusive or in the blue range between 400 nm inclusive and 460 nm inclusive, such as between 400 nm and 450 nm inclusive. It has been found that the phosphor may be excited particularly efficiently with primary radiation in these ranges.

According to at least one embodiment, the lighting device is a light-emitting diode, abbreviated to LED, in particular a conversion LED. The lighting device may then be configured to emit white or green light.

In combination with the phosphor present in the lighting device, the lighting device may be configured to emit green light in full conversion and white light in partial conversion.

According to at least one embodiment, the lighting device is configured to emit green light in full conversion. The lighting device may comprise the phosphor with the general molecular formula NaᵥKₓRb_{y}Li_{z}Cs_{w}(Li₃SiO₄)₄:E as the only phosphor. The lighting device of this embodiment is suitable in particular for applications in which saturated green emission is required, such as for video projection, for example in a movie theater, office or at home, head-up displays, for light sources with an adjustable color rendering index or adjustable color temperature, light sources with a spectrum matched to the application, such as store lighting or FCI (feeling of contrast index) lamps. FCI lamps are lighting devices which are configured to generate white light with a particularly high color contrast index. Conversion light-emitting diodes or lighting devices of this embodiment are also suitable for colored spotlights, wall lighting or moving heads, particularly in stage lighting. According to at least one embodiment, the lighting device comprises a conversion element. In particular, the conversion element comprises or consists of the phosphor. The phosphor converts the primary electromagnetic radiation at least partially or fully into secondary electromagnetic radiation.

According to at least one embodiment, the overall radiation of the lighting device is white mixed radiation. The lighting device or the conversion element of this embodiment may comprise a red phosphor in addition to the phosphor. A lighting device of this embodiment is suitable in particular for the backlighting of display elements, such as displays.

According to at least one embodiment, the phosphor converts the primary electromagnetic radiation partially into secondary electromagnetic radiation. This may also be referred to as partial conversion. The overall radiation emerging from the lighting device is then composed of the primary and secondary radiation, in particular white mixed radiation.

According to at least one embodiment, besides the phosphor, the conversion element comprises a second and/or third phosphor. For example, the phosphors are embedded in a matrix material. Alternatively, the phosphors may also be present in a converter ceramic.

The lighting device may comprise a second phosphor for the emission of radiation from the red spectral range.

### Exemplary Embodiment

The exemplary embodiment AB with the molecular formula Na_{1.18}K_{0.96}Rb_{0.92}Li_{0.82}Cs_{0.12}(Li₃SiO₄)₄:Eu was produced as follows: Li₂CO₃, Na₂CO₃, K₂CO₃, Rb₂CO₃, Cs₂CO₃, SiO₂ and Eu₂O₃ were mixed in the amounts shown in Table 1 and the mixture was heated in an open nickel crucible at a temperature of 750° C. under a forming gas atmosphere (N₂ : H₂ = 80:20) for four hours. Alternatively, the heating may be carried out under a 100% H₂ atmosphere or in a forming gas atmosphere with up to 20% N₂, remainder H₂. After cooling, an agglomerate of green single crystals of the phosphor is obtained, and these were separated from one another in an agate mortar

| Reactant | Mass / g |
|---|---|
| Cs₂CO₃ | 1.493 |
| Rb₂CO₃ | 1.058 |
| K₂CO₃ | 0.633 |
| Na₂CO₃ | 0.486 |
| Li₂CO₃ | 4.086 |
| SiO₂ | 2.210 |
| EU₂O₃ | 0.032 |

The phosphor exhibits emission in the green spectral range of the electromagnetic spectrum. By single-crystal diffractometry, the molecular formula Na_{1.18}K_{0.96}Rb_{0.92}Li_{0.82}Cs_{0.12} (Li₃SiO₄) ₄:Eu²⁺ may be assigned to the phosphor. Because of the negligible scattering contribution of Eu at the activator concentration used, Eu was not separately taken into account in the refinement.

### BRIEF DESCRIPTION OF THE DRAWINGS

Further advantageous embodiments and developments may be found in the exemplary embodiments described below in connection with the figures.

FIG. 1 shows a detail of the crystal structure of an exemplary embodiment of the phosphor.

FIG. 2 shows a Rietveld refinement of the X-ray diffraction powder diffractogram of an exemplary embodiment of the phosphor.

FIG. 3 shows an emission spectrum of an exemplary embodiment of the phosphor.

FIG. 4 shows the Kubelka-Munk function of an exemplary embodiment of the phosphor.

FIG. 5 shows an emission spectrum of two comparative examples.

FIG. 6 shows the thermal quenching behavior of an exemplary embodiment of the phosphor.

FIGS. 7 to 9 show schematic sectional representations of lighting devices.

FIG. 10 shows an emission spectrum of a comparative example.

### DETAILED DESCRIPTION

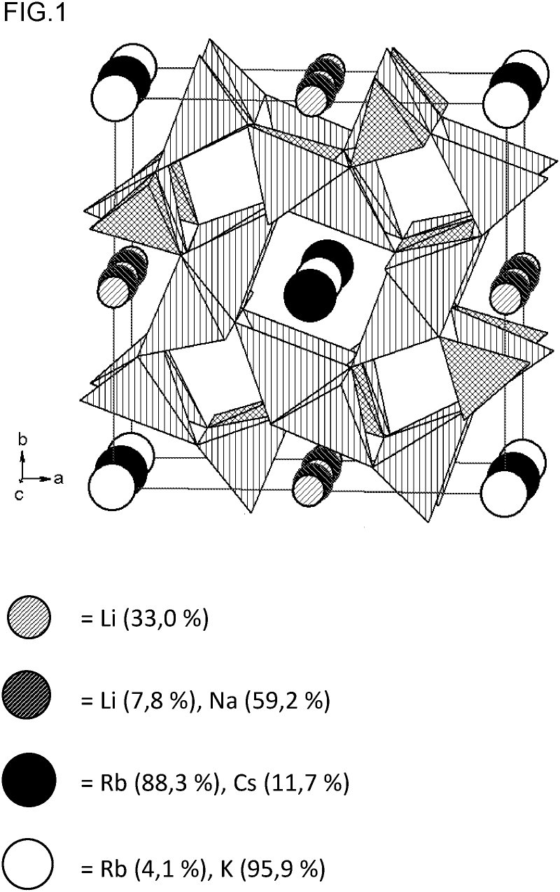

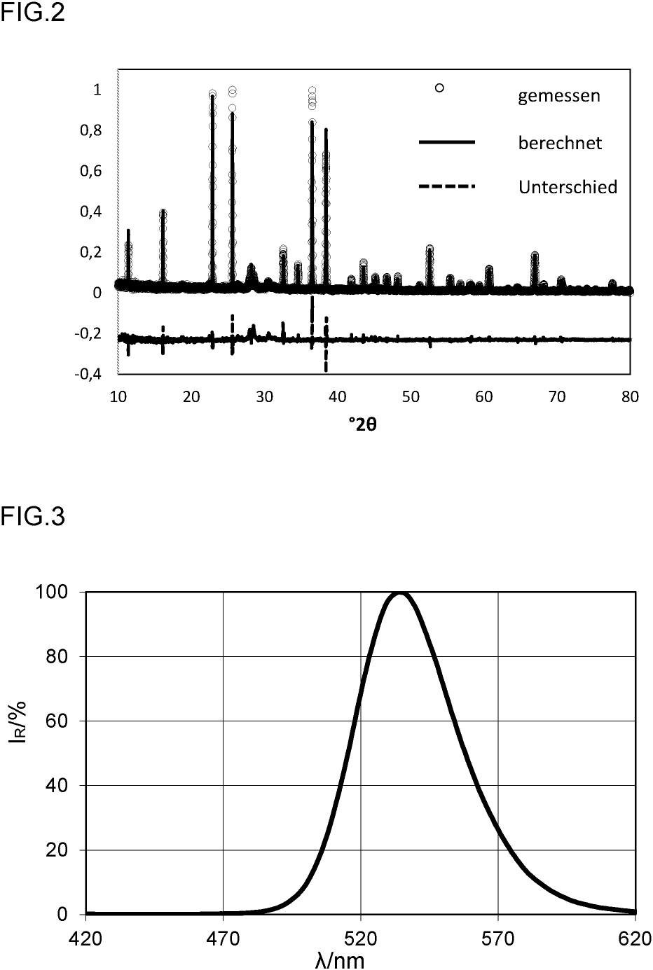

FIG. 1 shows the tetragonal crystal structure of the phosphor having the molecular formula Na_{1.18}K_{0.96}Rb_{0.92}Li_{0.82}Cs_{0.12} (Li₃SiO₄) ₄:Eu²⁺. The filled circles represent Rb atoms (88.3%) and Cs atoms (11.7%), the unfilled circles represent Rb atoms (4.1%) and K atoms (95.9%), the unfilled circles with lines represent Li atoms (33.0%), and the filled circles with lines represent Li atoms (7.8%) and Na atoms (59.2%). The diagonally hatched polyhedra represented larger are LiO₄ tetrahedra and the checkered polyhedra represented smaller are SiO₄ tetrahedra. The (Li₃SiO₄) structural units comprise SiO₄ and LiO₄ tetrahedra, oxygen occupying the vertices and Li or Si respectively occupying the center of the tetrahedra. The (Li₃SiO₄) structural units form an (Li₃SiO₄) substructure which corresponds to the (Li₃SiO₄) substructure of known lithosilicates (J. Hofmann, R. Brandes, R. Hoppe, Neue Silicate mit “Stuffed Pyrgoms” [New silicates with Stuffed Pyrgoms]: CsKNaLi₉ {Li[SiO₄]} ₄, CsKNa₂Li₈{ Li[SiO₄]} ₄, RbNa₃Li₈{Li[SiO₄]} ₄, and RbNaLi₄{Li[SiO₄]} ₄, Z. Anorg. Allg. Chem., 1994, 620, 1495 -1508.), but the phosphor differs from known lithosilicates by the different occupancy of the two types of channels. The (Li₃SiO₄) substructure forms two types of channels along the crystallographic c axis. The first type of channels is occupied by the heavier alkali metals Cs, Rb and K. In this case, K and Rb are arranged alternately, Rb being partially substituted with Cs (11.7%) and K being partially substituted with Rb (4.1%) . The second type of channels is occupied by the lighter alkali metals Na and Li. In the second type of channels, not all Na and Li positions are fully occupied, the Na position being occupied by Na to 59.2% and Li to 7.8%, and the Li position being occupied to 33% by Li. The sum of the occupancy of the second type of channels was set to 100% in the refinement, in order to ensure charge neutrality. This new type of crystal structure of Na_{1.18}K_{0.96}Rb_{0.92}Li_{0.82}Cs_{0.12} (Li₃SiO₄)₄:Eu²⁺ is not previously known. The crystal structure is isostructural with the crystal structure of CsNaKLi (Li₃SiO₄) ₄ and CsNaRbLi (Li₃SiO₄) ₄ (J. Hofmann, R. Brandes, R. Hoppe, Neue Silicate mit “Stuffed Pyrgoms” [New silicates with Stuffed Pyrgoms] : CsKNaLi₉{Li[SiO₄]}₄, CsKNa₂Li₈ {Li [SiO₄]} ₄, RbNa₃Li₈ {Li[SiO₄]} ₄, and RbNaLi₄ {Li [SiO₄]}₄, Z. Anorg. Allg. Chem., 1994, 620, 1495 - 1508.). As described, Li in the crystal structure occupies on the one hand positions within the (Li₃SiO₄)⁻ substructure and on the other hand within the channels formed by the (Li₃SiO₄)- substructure, for which reason a nomenclature of the molecular formula may be Na_{1.18}K_{0.96}Rb_{0.92}Li_{0.82}CS_{0.12} (Li₃SiO₄)₄:Eu²⁺, Na_{1.18}K_{0.96}Rb_{0.92}Cs_{0.12}Li_{12.82}Si₄O₁₆:Eu²⁺ also being usable. The phosphor crystallizes in the space group I4/m. The crystal structure was determined by means of single-crystal (details in Tables 2, 3 and 4 below) and powder X-ray diffraction experiments (FIG. 2).

The crystallographic data of Na_{1.18}K_{0.96}Rb_{0.92}Li_{0.82}Cs_{0.12} (Li₃SiO₄)₄:Eu²⁺ are shown in Table 2.

TABLE 2

| Molecular formula | CS_{0.12}Rb_{0.92}K_{0.96}Na_{1.18}Li_{0.82} (Li₃SiO₄) ₄:Eu |
|---|---|
| Molar mass / g×mol⁻¹ | 308.30 (without Eu) |
| Crystal system | Tetragonal |
| Space group | I4/m (no 87) |
| a / Å | 11.0063(5) |
| b / Å | 11.0063(5) |
| c / Å | 6.3336 (3) |
| Cell volume / Å³ | 767.24 (8) |
| Density / g×cm⁻³ | 2.669 |
| T / K | 296 |
| Radiation | Cu-Kα (λ = 1.542 Å) |
| Measurement range | 5.7 < θ < 74.3 |
| | -13 ≤ h ≤ 13 |
| | -13 ≤ k ≤ 13 |
| | -7 ≤ 1 ≤ 7 |
| Total reflections | 3550 |
| Independent reflections | 423 |
| Number of parameters | 32 |
| Rᵢₙₜ, Rσ | 0.0346, 0.0222 |
| Δρmax, Δρmin / eÅ⁻³ | 0.42/-0.44 |
| R₁ (obs/all) | 0.026/0.027 |
| wR2 (obs/all) | 0.066/0.066 |
| GooF (obs/all) | 1.14/1.14 |

The atom layers of Na_{1.18}K_{0.96}Rb_{0.92}Li_{0.82}Cs_{0.12} (Li₃SiO₄) ₄ :Eu²⁺ are shown in Table 3.

TABLE 3

| Atom | x | y | z | Occupanc y | Uiso |
|---|---|---|---|---|---|
| Rb01 | ½ | ½ | 0 | 0.883 (11 ) | 0.0176 (3) |
| Cs01 | ½ | ½ | 0 | 0.117 (11 ) | 0.0176 (3) |
| K002 | ½ | ½ | ½ | 0.959 (8) | 0.0120(6) |
| Rb02 | ½ | ½ | ½ | 0.041 (8) | 0.0120(6) |
| Si03 | 0.21585(8) | 0.42217 (8) | ½ | 1 | 0.0060 (3) |
| Na04 | 0 | ½ | ¾ | 0.592 (13 ) | 0.0113 (12 ) |
| Li04 | 0 | ½ | ¾ | 0.078 (13 ) | 0.0113 (12 ) |
| 0005 | 0.0996(2) | 0.3307 (2) | ½ | 1 | 0.0106(5) |
| 0006 | 0.29593 (15 ) | 0.40548 (16 ) | 0.2842 (3 ) | 1 | 0.0110 (4) |
| 0007 | 0.1631(2) | 0.5621(2) | ½ | 1 | 0.0093(5) |
| Li08 | 0.0749(6) | 0.7118(6) | ½ | 1 | 0.0124 (13 ) |
| Li09 | 0.3857(4) | 0.2575(5) | 0.2574 (7 ) | 1 | 0.0173 (10 ) |
| Li10 | 0 | ½ | ½ | 0.33 (5) | 0.022(11) |

The anisotropic displacement parameters of Na_{1.18}K_{0.96}Rb_{0.92}Li_{0.82}Cs_{0.12} (Li₃SiO₄) _{4:} Eu²⁺ are shown in Table 4.

TABLE 4

| Atom | U₁₁ | U₂₂ | U₃₃ | U₂₇ | U₁₃ | U₁₂ |
|---|---|---|---|---|---|---|
| Rb01 | 0.0199 (3) | 0.0199 (3) | 0.0131 (4) | 0 | 0 | 0 |
| Ca01 | 0.0199 (3) | 0.0199 (3) | 0.0131 (4) | 0 | 0 | 0 |
| K002 | 0.0107 (6) | 0.0107 (6) | 0.0146 (9) | 0 | 0 | 0 |
| Rb02 | 0.0107 ( 6 ) | 0.0107 (6) | 0.0146 (9) | 0 | 0 | 0 |
| Na04 | 0.0109(13) | 0.0109 (13) | 0.012(2) | 0 | 0 | 0 |
| L104 | 0.0109 (13) | 0.0109 (13) | 0.012 (2) | 0 | 0 | 0 |

FIG. 2 shows a Rietveld refinement of the X-ray diffraction powder diffractogram of Na_{1.18}K_{0.96}Rb_{0.92}Li_{0.82}Cs_{0.12}(Li₃SiO₄) ₄:Eu. With the aid of the measured X-ray powder diffractogram, the high purity of the phosphor may be seen. The superposition of the measured reflections with the calculated reflections is in this case represented in the upper diagram. The differences between the measured and calculated reflections are represented in the lower diagram.

FIG. 3 shows the emission spectrum of Na_{1.18}K_{0.96}Rb_{0.92}Li_{0.82}Cs_{0.12} (Li₃SiO₄)₄:Eu²⁺. The wavelength is plotted in nanometers on the x axis and the relative intensity in percent is plotted on the y axis. In order to measure the emission spectrum, a powder of the phosphor was excited with primary radiation having a wavelength of 400 nm. The phosphor has a peak wavelength of 534 nm and a dominant wavelength of 543 nm. The full-width at half maximum is 42.3 nm and the color point in the CIE color space is at the coordinates CIE-x: 0.259 and CIE-y: 0.697. As may be seen, the emission spectrum of the phosphor exhibits only one emission peak. The peak wavelength therefore represents not only the absolute maximum but also the only maximum within the emission spectrum.

In response to excitation of a powder of the phosphor with primary radiation having a wavelength of 460 nm (not shown), the phosphor exhibits a peak wavelength of 534 nm and a dominant wavelength of 542.7 nm. The full-width at half maximum is 43.5 nm and the color point in the CIE color space has the coordinates CIE-x: 0.257 and CIE-y: 0.702. Here again, the emission spectrum of the phosphor has only one emission peak and the peak wavelength represents the absolute and only maximum.

In contrast, the emission spectrum shown in FIG. 10 of the phosphor Cs_{4-x-y-z}RbₓNa_{y}Li_{z} [Li₃SiO₄]₄:Eu has two emission peaks and therefore undesired double emission.

The emission of the phosphor exhibits a large overlap with the transmission range of a standard green filter, so that only little light is lost and the achievable color space is large. The phosphor Na_{1.18}K_{0.96}Rb_{0.92}Li_{0.82}Cs_{0.12} (Li₃SiO₄)₄:Eu²⁺ is therefore suitable in particular for conversion LEDs for backlighting applications for displays.

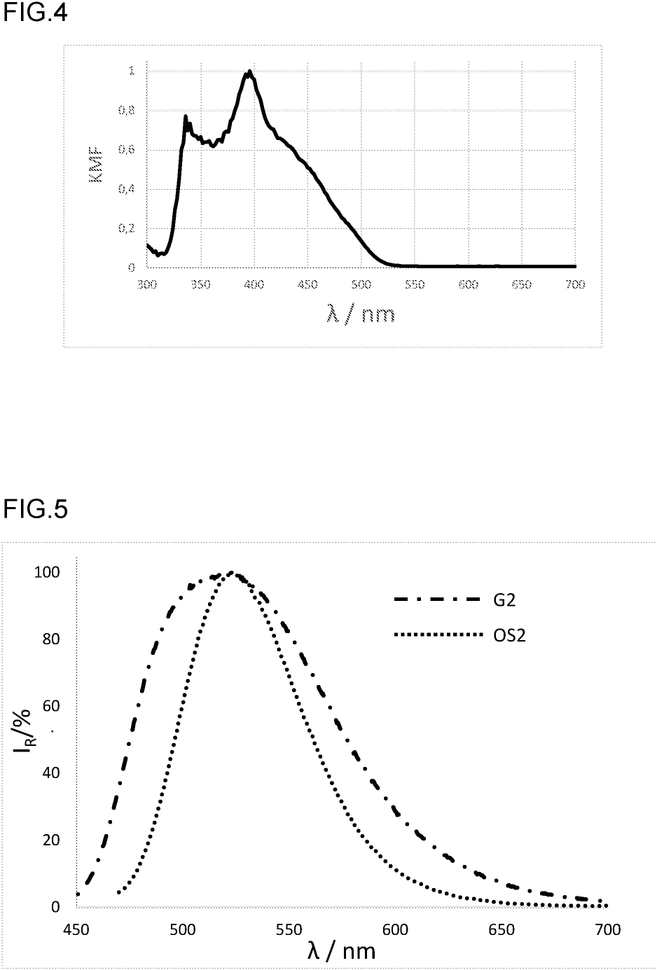

FIG. 4 shows a normalized Kubelka-Munk function (KMF), plotted against the wavelength λ in nm, for Na_{1.18}K_{0.96}Rb_{0.92}Li_{0.82}Cs_{0.12} (Li₃SiO₄)₄:Eu²⁺. The KMF was in this case calculated as follows:

KMF = R_{inf})²/2R_{inf}, where R_{inf} corresponds to the diffuse reflection (remission) of the phosphor.

It may be seen from FIG. 4 that the phosphor can be excited efficiently with primary radiation between 330 nm and 500 nm. High KMF values mean a high absorption in this range.

FIG. 5 shows the emission spectra of the known phosphors Lu₃(Al,Ga)₅O₁₂:Ce (G2) and (Sr,Ba)₂SiO₄:Eu (OS2).

Table 5 shows a comparison of the spectral data of the phosphor Na_{1.18}K_{0.96}Rb_{0.92}Li_{0.82}Cs_{0.12} (Li₃SiO₄)₄:Eu²⁺ (AB) with the known phosphors Lu₃(Al,Ga)₅O₁₂:Ce (G2) and (Sr,Ba)₂SiO₄:Eu (OS2).

TABLE 5

| | AB | G2 | OS2 |
|---|---|---|---|
| CIE-x | 0.259 | 0.287 | 0.263 |
| CIE-y | 0.697 | 0.536 | 0.645 |
| λₚₑₐₖ / nm | 534.0 | 537.4 | 536.3 |
| λ_{dom} / nm | 543.0 | 541.3 | 541.5 |
| FWHM / nm | 42.3 | 102.0 | 65.3 |
| LER / lm· Wₒₚₜ⁻¹ | 570.9 | 418.6 | 490.8 |
| Color purity / % | 90.2 | 49.0 | 75.3 |

All three phosphors exhibit a similar dominant wavelength. The phosphor AB, however, exhibits a much higher luminous efficiency (LER) and a significantly higher color purity. This leads to a better color purity and to a better overall efficiency.

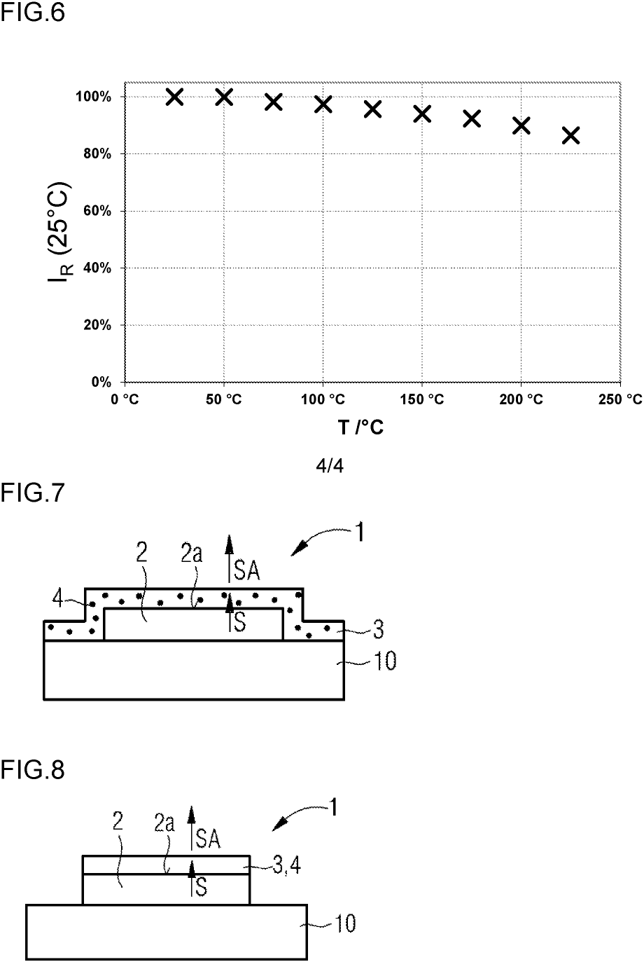

The thermal quenching behavior of the phosphor Na_{1.18}K_{0.96}Rb_{0.92}Li_{0.82}Cs_{0.12} (Li₃SiO₄)₄:Eu²⁺ is represented in FIG. 6. The phosphor was excited with primary radiation having a wavelength of 400 nm at various temperatures from 25 to 225° C., during which its emission intensity was recorded. The phosphor exhibits only a small loss of emission intensity at typical temperatures which prevail in a conversion LED, in particular temperatures above 140° C. Even at 200° C., the loss is only 10%. The thermal quenching behavior is therefore even better than that of Lᵤ₃Al₅O₁₂:Ce. The phosphor may therefore advantageously be used even at relatively high operating temperatures in conversion LEDs.

FIGS. 7 to 9 respectively show schematic side views of various embodiments of lighting devices as described here, in particular conversion LEDs.

The conversion LEDs of FIGS. 7 to 9 comprise at least one phosphor as described here. In addition, there may be a further phosphor or a combination of phosphors in the conversion LED. The additional phosphors are known to the person skilled in the art and will therefore not be explicitly mentioned at this point.

The conversion LED according to FIG. 7 comprises a semiconductor layer sequence 2, which is arranged on a substrate 10. The substrate 10 may, for example, be configured to be reflective. A conversion element 3 in the form of a layer is arranged over the semiconductor layer sequence 2. The semiconductor layer sequence 2 comprises an active layer (not shown), which emits primary radiation with a wavelength of from 340 nm to 460 nm during operation of the conversion LED. The conversion element 3 is arranged in the beam path of the primary radiation S. The conversion element 3 comprises a matrix material, for example a silicone, epoxy resin or hybrid material, and particles of the phosphor 4.

The phosphor 4 is capable of converting the primary radiation S during operation of the conversion LED at least partially or fully into secondary radiation SA in the green spectral range, in particular with a peak wavelength of between 529 nm and 539 nm inclusive. In the conversion element 3, the phosphor 4 is distributed homogeneously in the matrix material within the scope of manufacturing tolerance.

Alternatively, the phosphor 4 may also be distributed with a concentration gradient in the matrix material.

Alternatively, the matrix material may also be omitted, so that the phosphor 4 is formed as a ceramic converter.

The conversion element 3 is applied fully over the radiation exit surface 2a of the semiconductor layer sequence 2 and over the side faces of the semiconductor layer sequence 2, and is in direct mechanical contact with the radiation exit surface 2a of the semiconductor layer sequence 2 and the side faces of the semiconductor layer sequence 2. The primary radiation S may also emerge through the side faces of the semiconductor layer sequence 2.

The conversion element 3 may for example be applied by injection-molding, transfer-molding or spray-coating methods. Furthermore, the conversion LED comprises electrical contacts (not shown here), the configuration and arrangement of which are known to the person skilled in the art.

Alternatively, the conversion element may also be prefabricated and applied onto the semiconductor layer sequence 2 by means of a so-called pick-and-place process.

A further exemplary embodiment of a conversion LED 1 is shown in FIG. 8. The conversion LED 1 comprises a semiconductor layer sequence 2 on a substrate 10. The conversion element 3 is formed on the semiconductor layer sequence 2. The conversion element 3 is formed as a platelet. The platelet may consist of particles of the phosphor 4 which are sintered together, and it may therefore be a ceramic platelet, or the platelet comprises for example glass, silicone, an epoxy resin, a polysilazane, a polymethacrylate or a polycarbonate as matrix material with particles of the phosphor 4 embedded therein.

The conversion element 3 is applied surface-wide over the radiation exit surface 2a of the semiconductor layer sequence 2. In particular, no primary radiation S emerges through the side faces of the semiconductor layer sequence 2, but instead it emerges predominantly through the radiation exit surface 2a. The conversion element 3 may be applied on the semiconductor layer sequence 2 by means of an adhesion layer (not shown), for example consisting of silicone.

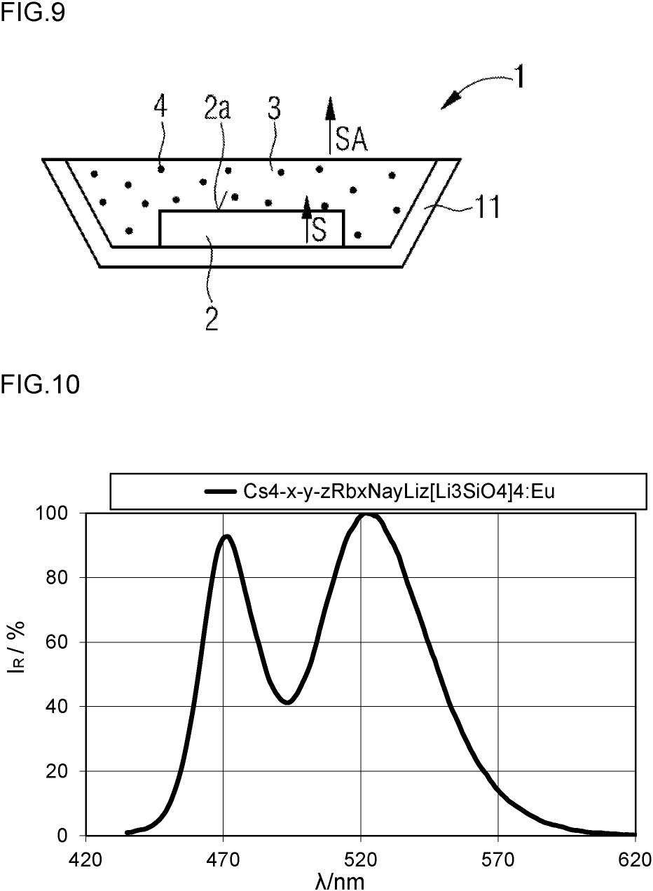

The conversion LED 1 according to FIG. 9 comprises a housing 11 with a recess. A semiconductor layer sequence 2, which comprises an active layer (not shown), is arranged in the recess. The active layer emits primary radiation S with a wavelength of from 340 nm to 460 nm during operation of the conversion LED.

The conversion element 3 is formed as an encapsulation of the layer sequence in the recess and comprises a matrix material, for example a silicone, and a phosphor 4, for example Na_{1.18}K_{0.96}Rb_{0.92}Li_{0.82}Cs_{0.12} (Li₃SiO₄)₄:Eu. The phosphor 4 converts the primary radiation S at least partially into secondary radiation SA during operation of the conversion LED 1. Alternatively, the phosphor converts the primary radiation S fully into secondary radiation SA.

In the exemplary embodiments of FIGS. 7 to 9, it is also possible for the phosphor 4 to be arranged spatially separated from the semiconductor layer sequence 2 or the radiation exit surface 2a in the conversion element 3. This may, for example, be achieved by sedimentation or by application of the conversion layer on the housing.

For example, in contrast to the embodiment of FIG. 9, the encapsulation may consist only of a matrix material, for example silicone, the conversion element 3 being applied on the encapsulation at a distance from the semiconductor layer sequence 2 as a layer on the housing 11 and on the encapsulation.

The exemplary embodiments described in connection with the figures, and the features thereof, may also be combined with one another according to further exemplary embodiments, even if such combinations are not explicitly shown in the figures. Furthermore, the exemplary embodiments described in connection with the figures may comprise additional or alternative features according to the description in the general part.

### LIST OF REFERENCES

1 lighting device or conversion LED
2 semiconductor layer sequence or semiconductor chip
2a radiation exit surface
3 conversion element
4 phosphor
10 substrate
11 housing
S primary radiation
SA secondary radiation
LED light-emitting diode
LER luminous efficiency
W watt
lm lumen
λ_{dom} dominant wavelength
ppm parts per million
AB exemplary embodiment
g gram
IR relative intensity
mol% molar percent
KMS Kubelka-Munk function
K kelvin
cm centimeter
nm nanometer
°2θ degrees 2 Theta
T temperature
°C degrees Celsius

1. A phosphor having the general molecular formula NaᵥKₓRb_{y}Li_{z}Cs_{w}(Li₃SiO₄)_{4:}E, wherein:
v+x+y+z+w = 4;
0 < v < 4;
0 < x < 4;
0 < y < 4;
0 < z < 4;
0 < w < 4; and
E = Eu, Ce, Yb, Mn, or combinations thereof.

2. The phosphor as claimed in claim 1, wherein:
0 < v≤ 3;
0 < x ≤ 3;
0 < y ≤ 3;
0 < z ≤ 3; and
0 < w ≤ 3.

3. The phosphor as claimed in claim 1, wherein:
0 < v ≤ 2;
- 0 < y ≤ 2;
0 < z ≤ 2; and
0 < w ≤ 2.

4. The phosphor as claimed in claim 1 , wherein:
0.05 ≤ v ≤ 1.50;
0.05 ≤ x ≤ 1.50;
0.05 ≤ y ≤ 1.50;
0.05 ≤ z ≤ 1.50; and
0.05 ≤ w ≤ 1.50.

5. The phosphor as claimed in claim 1 , wherein:
0.50 ≤ v ≤ 1.50;
0.50 ≤ x ≤ 1.50;
0.50 ≤ y ≤ 1.50;
0.50 ≤ z ≤ 1.50; and
0.05 ≤ w ≤ 0.5.

6. The phosphor as claimed in claim 1, wherein:
1.00 ≤ v ≤ 1.40;
0.80 ≤ x ≤ 1.20;
0.80 ≤ y ≤ 1.20;
0.60 ≤ z ≤ 1.00; and
0.05 ≤ w ≤ 0.30.

7. The phosphor as claimed in claim 1 , wherein:
1.08 ≤ v ≤ 1.28;
0.86 ≤ x ≤ 1.06;
0.82 ≤ y ≤ 1.02;
0.72 ≤ z ≤ 0.92; and
0.05 ≤ w ≤ 0.22.

8. The phosphor as claimed in claim 1 , wherein:
1.16 ≤ v ≤ 1.20;
0.94 ≤ x ≤ 0.98;
0.90 ≤ x ≤ 0.94;
0.80 ≤ z ≤ 0.84, and
0.10 ≤ w ≤ 0.14.

9. The phosphor as claimed in claim 1, wherein the crystal structure of which is tetragonal.

10. The phosphor as claimed in claim 9, wherein the phosphor crystallizes in the space group I4/m.

11. The phosphor as claimed in claim 1, wherein the phosphor has a peak wavelength ranging from 529 nm to 539 nm inclusive.

12. The phosphor as claimed in claim 1, wherein the phosphor has a full-width at half maximum ranging from 40 nm to 45 nm.

13. A lighting device comprising the phosphor as claimed in claim 1.

14. The lighting device as claimed in claim 13, further comprising:
a semiconductor layer sequence configured to emit primary electromagnetic radiation; and
a conversion element comprising the phosphor; and wherein the conversion element at least partially converts the primary electromagnetic radiation into secondary electromagnetic radiation .
